(19) United States
(12) Patent Application Publication
(10) Pub. No.: US 2026/0251854 A1
(43) Pub. Date: Aug. 27, 2026

(54) LASER FERRULE-TO-OPTICAL FIBER FERRULE RETAINING CLIP FOR PLUGGABLE OPTICAL TRANSCEIVER MODULES

(71) Applicant: MARVELL ASIA PTE LTD, Singapore (SG)

(72) Inventor: Chris TOGAMI, San Jose, CA (US)

(21) Appl. No.: 19/549,598

(22) Filed: Feb. 25, 2026

Related U.S. Application Data
(60) Provisional application No. 63/764,131, filed on Feb. 27, 2025.

(51) Int. Cl. G02B 6/38

(52) U.S. Cl. CPC G02B 6/3888; G02B 6/3877

(57) ABSTRACT

A ferrule-to-ferrule retaining clip for applying axial compression forces on a laser ferrule and an optical fiber ferrule of a pluggable optical transceiver module includes: a bulk end configured to hold a strain relief tube of an optical fiber and abut the optical fiber ferrule; joints; a center member connected to the joints and configured to hold the laser ferrule and the optical fiber ferrule; locking members extending from the joints axially and configured to apply pressure against the laser ferrule; and side members extending axially from the bulk end to the joints, where the side members are convex shaped and configured to i) spread apart the locking members when compressed, and ii) cause the bulk end and the locking members to apply an axial compression force against the laser ferrule and the optical fiber ferrule when not compressed.

### CROSS-REFERENCE TO RELATED APPLICATIONS

This application claims the benefit of U.S. Provisional Application No. 63/764,131, filed on February 27, 2025. The entire disclosure of the application referenced above is incorporated herein by reference.

### FIELD

The present disclosure relates to laser assemblies of pluggable optical transceiver modules.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A small form-factor pluggable (SFP) transceiver module is a compact transceiver used in data communication and telecommunication networks for transferring data at high speeds (e.g., 10 gigabits per second (Gb/s) to 1.6 terabits per second (Tb/s) or faster). The SFP transceiver modules can receive and transmit data over fiber optical cables to and from network devices, such as switches and/or other network equipment having SFP ports. As an example, a switch can have multiple SFP ports configured to receive respective SFP transceiver modules.

### SUMMARY

A ferrule-to-ferrule retaining clip for applying axial compression forces on a laser ferrule and an optical fiber ferrule of a pluggable optical transceiver module is disclosed. The ferrule-to-ferrule retaining clip includes: a bulk end configured to hold a strain relief tube of an optical fiber and abut the optical fiber ferrule; joints; a center member connected to the joints and configured to hold the laser ferrule and the optical fiber ferrule; locking members extending from the joints axially and configured to apply pressure against the laser ferrule; and side members extending axially from the bulk end to the joints, where the side members are convex shaped and configured to i) spread apart the locking members when compressed, and ii) cause the bulk end and the locking members to apply an axial compression force against the laser ferrule and the optical fiber ferrule when not compressed.

In other features, the bulk end is split and configured to be pressed onto the strain relief tube. In other features, the bulk end is thicker in a center of the bulk end and decreases in thickness in radial directions away from an axial centerline of the bulk end.

In other features, the bulk end includes i) a planar inner surface and is configured to press against a ring, which is pressed onto the optical fiber ferrule, and ii) a curved outer surface that is on an opposite side of the bulk end than the planar inner surface.

In other features, the center member is cylindrical shaped and configured to hold a split sleeve, which is pressed over respective portions of the laser ferrule and the optical fiber ferrule. In other features, the ferrule-to-ferrule retaining clip further includes pivot arms that extend from the joints and to the center member. In other features, the center member is suspended between the joints by the pivot arms.

In other features, an inner diameter of the center member matches or is greater than an outer diameter of a split sleeve, which is pressed onto respective portions of the laser ferrule and the optical fiber ferrule.

In other features, the locking members are configured to press on a laser assembly collar, which is on a portion of the laser ferrule. In other features, the locking members extend from the joints axially away from the side members. In other features, each locking member of the locking members is ‘L’-shaped.

In other features, each locking member of the locking members includes an axially extending inner surface and an angled inner surface, which is at an acute angle relative to the axially extending inner surface. In other features, the locking members includes chamfered end surfaces aiding in spreading and bringing together the locking members.

In other features, each of the locking members includes a curved radially inner surface configured to abut a laser assembly collar, which is pressed on the laser ferrule. In other features, the ferrule-to-ferrule retaining clip is formed of injection molded plastic resin.

In other features, an optical transceiver module is disclosed and includes: an upper housing; a lower housing coupled to the upper housing; a laser package disposed in the lower housing; a laser assembly collar connected to the laser package; a split sleeve; a laser ferrule extending into the laser assembly collar and into a split sleeve; an optical fiber ferrule extending into the split sleeve; and a ferrule-to-ferrule retaining clip configured to apply axial compression forces on the laser ferrule and the optical fiber ferrule. The ferrule-to-ferrule retaining clip includes: a bulk end configured to abut the optical fiber ferrule; a center member configured to hold the laser ferrule and the optical fiber ferrule; locking members configured to apply pressure against the laser ferrule; and side members extending axially from the bulk end, where the side members are convex shaped and configured to spread apart the locking members when compressed.

In other features, the ferrule-to-ferrule retaining clip includes joints. The center member is connected to the joints. The locking members extend axially from the joints. The side members extend axially from the bulk end to the joints.

In other features, a method of installing a ferrule-to-ferrule retaining clip is disclosed. The ferrule-to-ferrule retaining clip includes a bulk end, side members, a center member and locking members. The method includes: obtaining an optical fiber ferrule with a strain relief tube; obtaining and pressing a split sleeve onto the optical fiber ferrule; obtaining a laser assembly collar and laser ferrule; inserting the optical fiber ferrule and split sleeve into the center member; pressing the bulk end onto the strain relief tube; controlling a motor via a controller to compress the side members to spread the locking members; inserting the laser ferrule into split sleeve, which is in the center member; and controlling the motor via the controller to release the locking members over the laser assembly collar and to axially compress the laser ferrule against the optical fiber ferrule.

In other features, compressing the side members includes moving the bulk end axially outward. In other features, releasing the locking members includes pressing the locking members over a laser output flange of the laser assembly collar.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a perspective view of a pluggable optical transceiver module that includes an example laser ferrule-to-optical fiber ferrule (or ferrule-to-ferrule (f-to-f)) retaining clip in accordance with the present disclosure.

FIG. 2 is a perspective view of a bottom portion of the pluggable optical transceiver module of FIG. 1 showing the f-to-f retaining clip.

FIG. 3 is a top view of the pluggable optical transceiver module including a cross-section line A-A.

FIG. 4 is a side cross-sectional view through line A-A of FIG. 3 of the pluggable optical transceiver module illustrating a confined area in which the f-to-f retaining clip is disposed and including a detail circle A.

FIG. 5 is a close-up detail view of a portion of FIG. 4 designated by detail circuit A.

FIG. 6 is a top view of the bottom portion of the pluggable optical transceiver module of FIG. 1 showing placement of the f-to-f retaining clip and including a detail circle B.

FIG. 7 is a close-up detail view of a portion of FIG. 6 designated by detail circle B.

FIG. 8 is a bottom perspective view of the f-to-f retaining clip.

FIG. 9 is a top perspective view of the f-to-f retaining clip.

FIG. 10 is an optic fiber end view of the f-to-f retaining clip.

FIG. 11 is a top view of the f-to-f retaining clip with a cross-section line B-B.

FIG. 12 is a side cross-sectional view through section line B-B of FIG. 11.

FIG. 13 is a laser end view of the f-to-f retaining clip.

FIG. 14 is a bottom view of the f-to-f retaining clip.

FIG. 15 is a perspective view of a compression tool holding the f-to-f retaining clip.

FIG. 16 illustrates an example method for installing the f-to-f retaining clip in accordance with an embodiment of the present disclosure.

FIG. 17 is a functional block diagram of an example communication system including pluggable optical transceiver modules in accordance with the present disclosure.

FIG. 18 is a functional block diagram of an example compression device in accordance with the present disclosure.

In the drawings, reference numbers may be reused to identify similar and/or identical elements.

### DESCRIPTION

Pluggable optical transceiver modules, such as SFP transceiver modules, quad SFP (QSFP) transceiver modules, QSFP double density (QSFP-DD) transceiver modules, and octal SFP (OSFP) transceiver modules, have corresponding dimension and tolerance requirements set according to a multi-source agreement (MSA) in order to be compatible with corresponding industry standard ports of network equipment. For example, some QSFP-DD transceiver modules have a mechanical component tolerances for circuit components such as for an integrated circuit (e.g., digital signal processor) including height tolerances and gap tolerances.

An optical transceiver module can include a laser package for generating a laser beam for transmission of optical signals over optical fibers. The laser package may include a beam focusing assembly with a laser output flange and laser ferrule. The laser ferrule is abutted to an optical fiber ferrule. The laser ferrule and the optical fiber ferrule may be small form factor (SFF) connectors, where the outer diameter of the ferrules is 1.25 millimeters (mm). This type of ferrule is often referred to as Lucent Connector (LC®). An optical channel in the laser ferrule needs to be aligned with an optical channel in the optical fiber ferrule or the laser signal through the optical channels is degraded or lost. Also, the laser ferrule needs to abut the optical fiber ferrule. If there is a gap between the laser ferrule and the optical fiber ferrule the optical signal is degraded or lost.

Available space in optical transceiver modules (e.g., a QSFP-DD transceiver module) is limited and compact mechanical solutions are needed to maintain optical signal connections between components. Traditional techniques for connecting a laser ferrule to an optical fiber ferrule can have complex assembly methods and are too bulky to fit within the stated optical transceiver modules.

The examples disclosed herein include a f-to-f retaining clip with a compact design that is easy to assemble onto a laser ferrule and an optical fiber ferrule. In an embodiment, the f-to-f retaining clip has a unitary structure including i) a bulk (or split) end that abuts an end ring of an optical ferrule, and ii) convex side members that when compressed rotate outward locking members (or jaws). The jaws are spread apart when the convex side members are compressed towards each other. The jaws rotate inward when compression force on the convex side members is decreased and/or released. During decompression of the convex side members, the jaws rotate inward against a laser output flange, which is pressed on the laser ferrule and as a result compresses the laser ferrule against the optical fiber ferrule. In an embodiment, the f-to-f retaining clip is formed of a plastic injected molded resin. The flexural modulus of the plastic material in combination with the closed radial design configuration of the convex side members provides compression forces via the split end and the jaws once installed. The f-to-f retaining clip includes a center member that holds a split sleeve, which maintains concentricity within of the ferrules and thus alignment of the channels of the laser ferrule and the optical fiber ferrule.

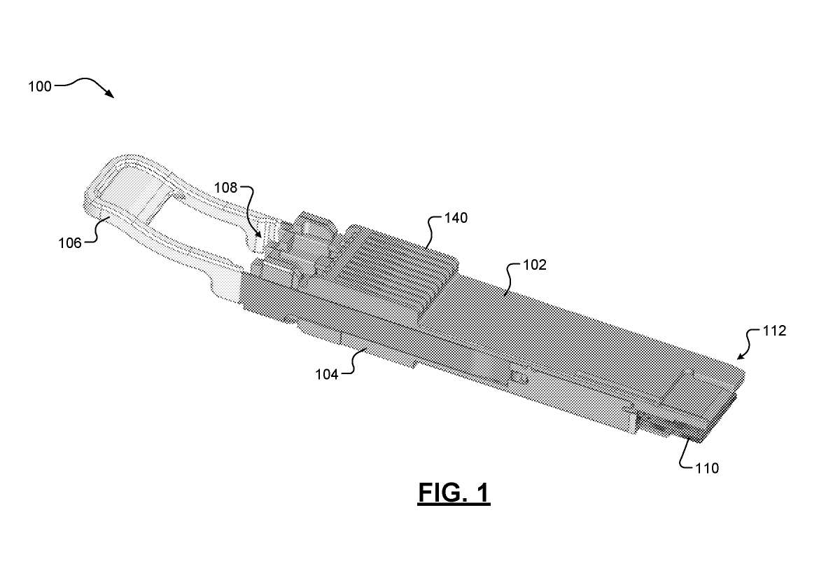

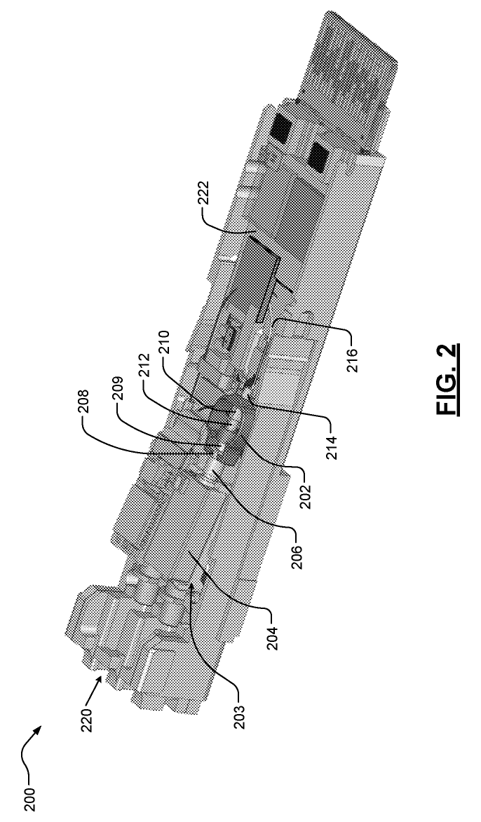

FIG. 1 shows a pluggable optical transceiver module 100 that includes a f-to-f retaining clip that is shown in FIGS. 2 and 4-15. The pluggable optical transceiver module 100 also includes an upper housing 102, a lower housing 104, a handle 106, connector ports 108, and a PCB 110. The upper housing 102 extends from behind the connector ports 108 to an insertable posterior end 112 of the pluggable optical transceiver module 100. The connector ports 108 are configured for receiving optical cables. Connector ports 108 are configured for reception and transmission of optical signals. In an embodiment, the pluggable optical transceiver module 100 is configured for optical communication via optical cables. The PCB 110 includes both optical and electrical components. The optical components are used for transmitting and receiving optical signals to and from the remotely located device via the connector ports 108. The electrical components are used for transmitting and receiving electrical signals to and from, for example, the motherboard of the network device that the pluggable optical transceiver module 100 is plugged into via the PCB 110. The upper housing 102 includes a heat sink 140 embedded, integrally formed, and/or included in the upper housing 102. The heat sink 140 include channels through which air or other suitable fluid flows. In an embodiment, the upper housing 102 and the heat sink 140 are a single component.

FIG. 2 is a perspective view of a bottom portion 200 of the pluggable optical transceiver module 100 of FIG. 1 showing the f-to-f retaining clip 202. The bottom portion 200 includes a laser assembly 203 that includes a laser package 204, a beam focusing assembly 206, a laser assembly collar 208, a split sleeve 209, a ring 210 on an optical fiber ferrule 212, a strain relief tube 214 and an optical fiber 216. A laser ferrule 700 (shown in FIG. 7) and the optical fiber ferrule 212 are partially located within the split sleeve 209. The stated components are used for optical transmission via an output port 220, which is controlled by a digital signal processor (DSP) 222. The f-to-f retaining clip 202 compresses the laser ferrule 700 against the optical fiber ferrule 212. In an example embodiment, the ferrules 700, 212 are SFF connectors. In an example embodiment, the ferrules 700, 212 are LC® type connectors.

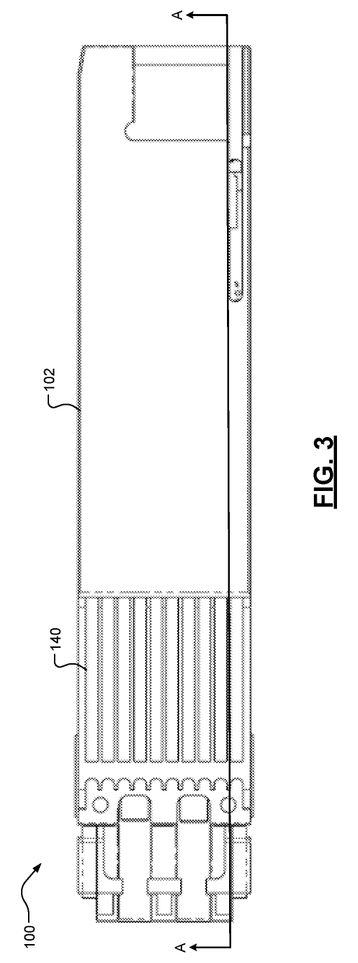

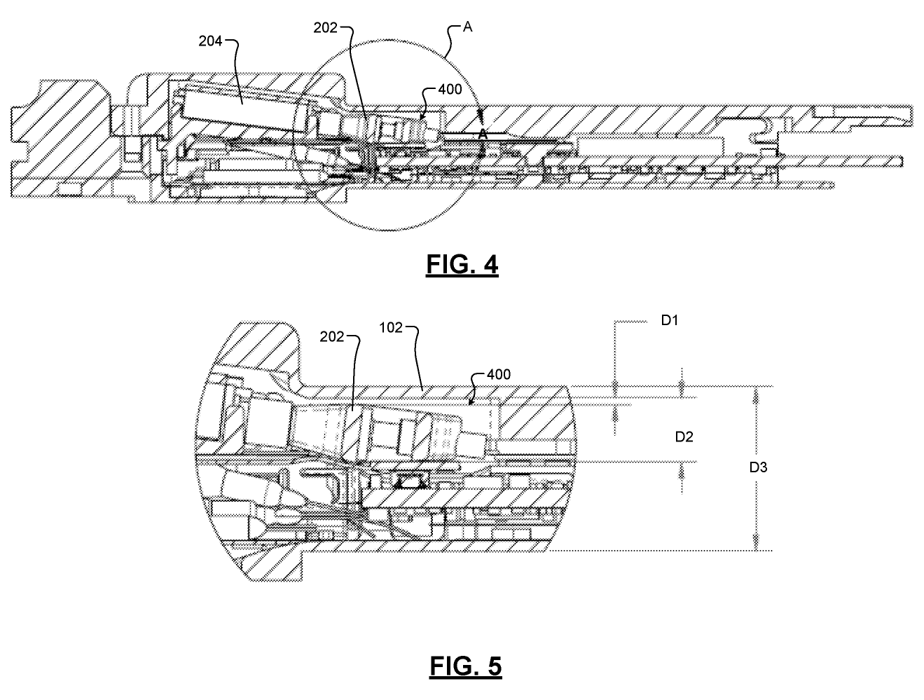

FIG. 3 shows the pluggable optical transceiver module 100 including a cross-section line A-A. FIG. 3 shows a top view of the upper housing 102 and the heat sink 140. FIG. 4 shows the pluggable optical transceiver module 100 illustrating a confined area 400 in which the f-to-f retaining clip 202 is disposed. The laser package 204 is also shown in FIG. 4. FIG. 5 is a detail view of a portion A of FIG. 4. FIG. 5 shows a distance D1 between a top of the f-to-f retaining clip 202 and a bottom surface of the upper housing 102. In an example embodiment, D1 is 0.31 mm. A height dimension D2 of the confined area 400 is also shown. This is the height constraint of the confined area 400 in which the f-to-f retaining clip 202 is disposed. In an example embodiment, D2 is 3.30 mm. An overall height dimension D3 is shown. In an example embodiment, D3 is 8.50 mm.

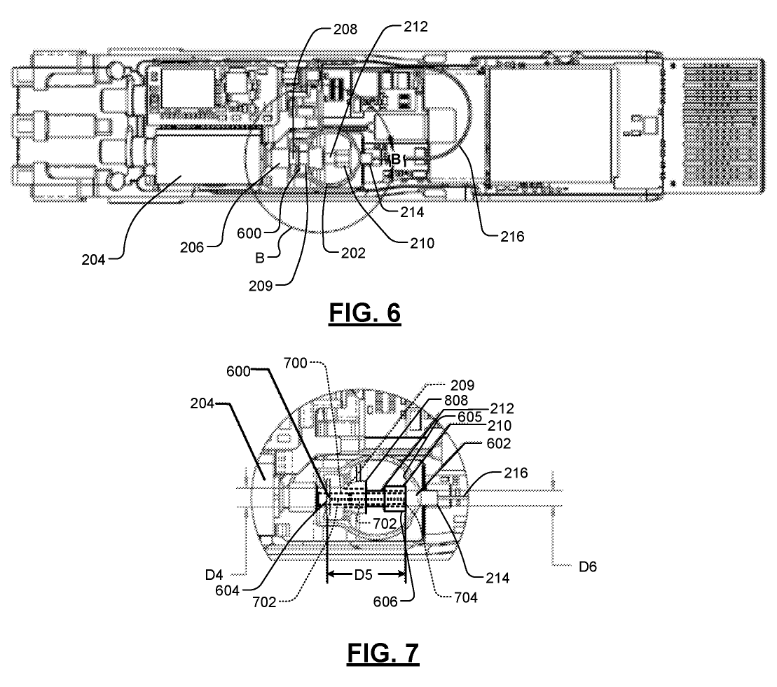

FIG. 6 shows the bottom portion 200 of the pluggable optical transceiver module 100 of FIG. 1 showing placement of the f-to-f retaining clip 202. FIG. 7 shows a detail view of a portion B of FIG. 6. The pluggable optical transceiver module 100 as shown in FIGS. 6-7 includes: the laser package 204; the beam focusing assembly 206; the laser assembly collar 208; the laser ferrule 700; the ring 210, which is on the optical fiber ferrule 212; the strain relief tube 214; and the optical fiber 216. The laser assembly collar 208 includes a laser output flange 600 and is disposed on a portion of the laser ferrule 700. The laser assembly collar 208 and the laser output flange 600 are annular shaped. The f-to-f retaining clip 202 includes a bulk (or split) end 602 that is pushed onto the strain relief tube 214.

The split sleeve 209 is pressed onto and maintains alignment of the ferrules 700, 212 including optical channels 702, 704 within the ferrules 700, 212. Portions of the ferrules 700, 212 are disposed within the center member 808. The split sleeve 209 is split axially to allow the split sleeve 209 to expand as it is pressed onto respective portions of the ferrules 700, 212. In an embodiment, the split sleeve 209 and the ferrules 700, 212 are formed of ceramic. The optical channel 704 extends through the optical fiber ferrule 212 and is in alignment with and contacts the optical fiber 216. The ring 210 is disposed on a portion of the optical fiber ferrule 212.

In FIG. 7, dimensions D4, D5 and D6 are shown. D4 is an outer diameter of the laser ferrule 700. D5 is a distance from an outer surface 604 of the laser output flange 600 closest to the laser package 204 to an inner surface 605 of the split end 602. In an example embodiment, D4 is 1.61 mm, D5 is 6.55 mm, and D6 is 1.25 mm.

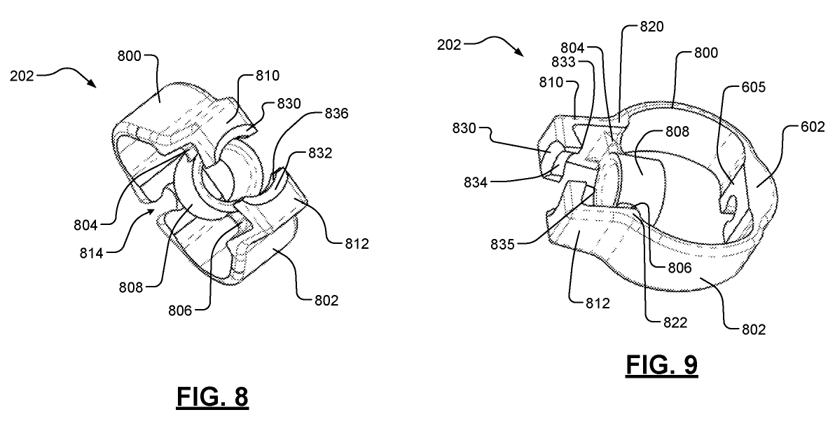

FIGS. 8-9 shows the f-to-f retaining clip 202 that includes the split end 602, side members 800, 802, pivot arms 804, 806, center member 808, and locking members (or jaws) 810, 812. The split end 602 includes the inner surface 605 and is split axially along the bottom side of the split end 602. The split (or open portion) of the split end 602 is designated 814 and is sized to receive the optical fiber strain relief tube 214 of FIG. 2. The split end 602 is more bulky than other portions of the f-to-f retaining clip 202 to provide a durable structure to handle being pushed on to the optical fiber strain relief tube 214 and stresses during compression of the side members 800, 802.

The side members 800, 802 are convex shaped and are configured to be compressed radially towards each other from a relaxed uncompressed state to a compressed state. When in the relaxed uncompressed state, the jaws 810, 812 are in an unseparated state. When the side members 800, 802 are in the compressed state the jaws 810, 812 are separated and more open than when the side members 800, 802 are in the relaxed uncompressed state. The jaws 810, 812 do not contact each other regardless of whether the f-to-f retaining clip 202 is installed.

The center member 808 is configured to receive and hold the laser ferrule 700 and the optical fiber ferrule 212 of FIG. 2. The center member 808 is cylindrically-shaped and has an inner diameter that matches or is slightly larger than the outer diameters of the ferrules 700, 212. The outer diameters of the ferrules 700, 212 may be the same.

The side members 800, 802 extend from the split end 602 to joints 820, 822. The side members 800, 802, the pivot arms 804, 806 and the jaws 810, 812 are connected at the joints 820, 822. These connections result in the jaws 810, 812 rotating relative to the pivot arms 804, 806 with the compression and decompression of the side members 800, 802.

The jaws 810, 812 include chamfered end surfaces 830, 832, which allows easier insertion of the f-to-f retaining clip 202 onto the flange 600 when the side members 800, 802 are compressed towards each other. When the side members 800, 802 are fully decompressed, radial inner surfaces 834, 836 of the jaws 810, 812 fully contact the laser assembly collar 208 of FIG. 2 and the chamfered end surfaces 830, 832 are at acute angles relative to a radially outer surface of the laser assembly collar 208. The radial inner surfaces 834, 836 are curved (or arched) to match curvature of the laser assembly collar 208 and to abut and press against the laser assembly collar 208.

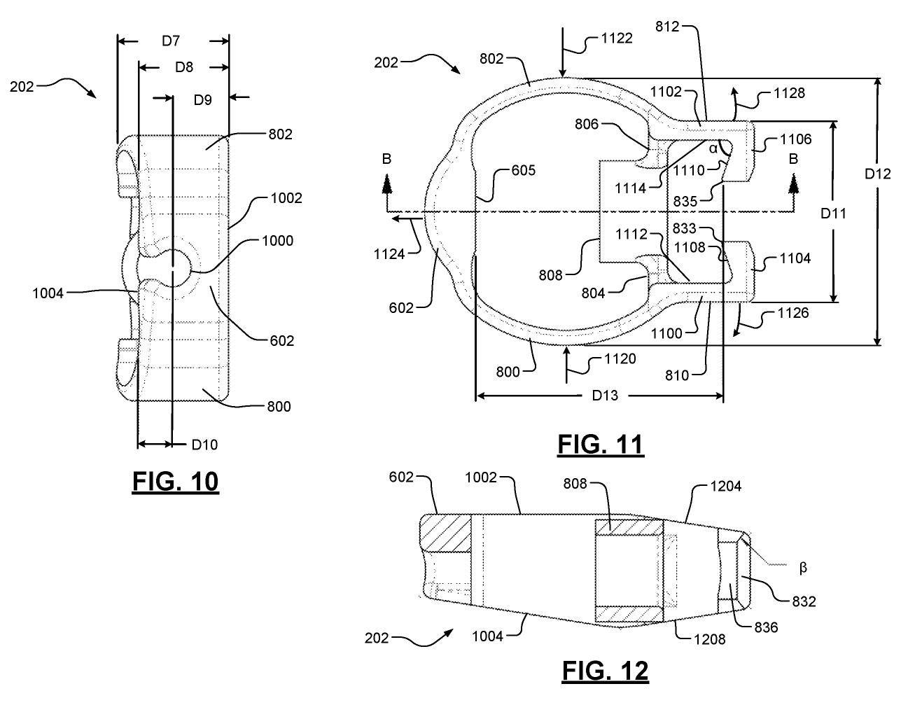

FIG. 10 shows an optic fiber end view of the f-to-f retaining clip 202, which includes the split end 602 and side members 800, 802. In FIG. 10, dimensions D7, D8, D9 and D10 are shown. D7 refers to an overall thickness of the f-to-f retaining clip 202. Dimension D8 refers to a thickness of the split end 602. D9 refers to a distance between i) a center of a circular opening 1000 in the split end 602 and ii) a planar top surface 1002, which is a top surface of both the split end 602 and the f-to-f retaining clip 202. D10 refers to distance between i) the center of the circular opening 1000 and ii) a bottom surface 1004 of both the split end 602 and the f-to-f retaining clip 202. In an example embodiment, D7 is 3.00 mm, D8 is 2.40 mm, D9 is 1.50 mm, and D10 is 0.90 mm.

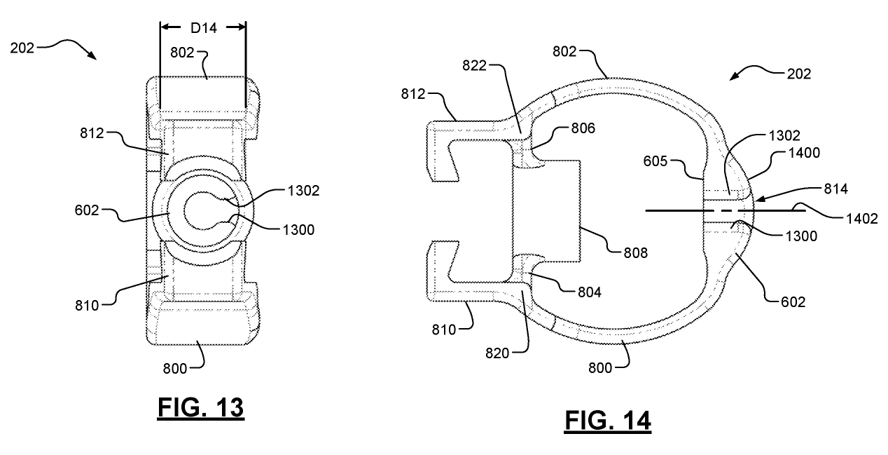

FIG. 11 shows a top view of the f-to-f retaining clip 202 including the split end 602, the side members 800, 802, the pivot arms 804, 806, the center member 808, and the jaws 810, 812. The jaws 810, 812 have ‘L’-shaped cross-sections, where first portions 1100, 1102 of the jaws 810, 812 extend axially and second portions 1104, 1106 of the jaws 810, 812 extend radially and perpendicular to the first portions 1100, 1102. The second portions 1104, 1106 of the jaws 810, 812 have angled inner surfaces 1108, 1110 that each extend at an acute angle α relative to a respective one of inner surfaces 1112, 1114 of the first portions 1100, 1102. In an example embodiment, the acute angle α is 75-85°. In one embodiment, the acute angle is 80°. The angled inner surfaces 1108, 1110 cause the jaws 810, 812 to provide more axial compression force against the outer surface 604 of the laser output flange 600, as opposed to if the angled inner surfaces 1108, 1110 extended perpendicular to inner surfaces 1112, 1114.

Direction at which compression forces may be applied to the side members 800, 802 and corresponding movement of the side members 800, 802 is represented by arrows 1120, 1122. When compression forces are applied, the split end 602 moves axially outward as represented by arrow 1124 and the jaws 810, 812 rotate outward as represented by arrows 1126, 1128.

FIG. 11 shows dimensions D11, D12, and D13. D11 refers to an overall width of the jaws 810, 812. D12 refers to an overall width of the side members 800, 802 and of the f-to-f retaining clip 202. D13 refers to a distance between the inner surface 605 and the edges 833, 835. In an example embodiment, D11 is 4.80 mm, D12 is 7.10 mm, and D13 is 6.55 mm ±0.03 mm.

FIG. 12 shows a side cross-sectional view through section line B-B of FIG. 11. In this cross-sectional view, the split end 602, the center member 808 and the jaw 812 are shown. The jaw 812 has the chamfered surface 832 and radial inner surface 836. The f-to-f retaining clip 202 has varying thickness in the vertical direction to accommodate variations in height of the area in which the f-to-f retaining clip is installed. As shown, the f-to-f retaining clip 202 has the planar top surface 1002, an angled top surface 1204, the angled bottom surface 1004 (or first angled bottom surface) and an angled bottom surface 1208 (or second angled bottom surface). Angle β is shown and is an angle of the chamfered surface 832 relative to axially extending surfaces 1210, 1212. In an example embodiment, the angle β is 45°.

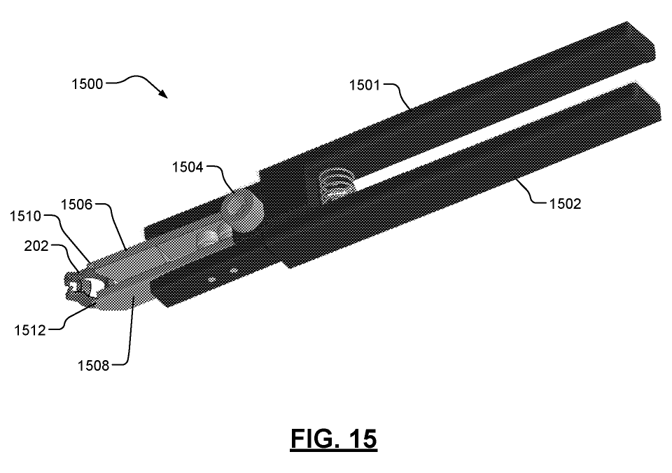

FIG. 13 shows a laser end view of the f-to-f retaining clip 202 showing the split end 602, the side members 800, 802, and the jaws 810, 812. The split end 602 has a ‘C’-shaped cross-section as shown having inner end surfaces 1300, 1302. A distance D14 is shown and refers to a thickness of each of the jaws 810, 812. In an example embodiment, D14 is 2.27 mm.

FIG. 14 shows a bottom view of the f-to-f retaining clip 202 including the split end 602, the side members 800, 802, the pivot arms 804, 806, the center member 808, the jaws 810, 812, and the joints 820, 822. The open portion 814 of the split end 602 is also shown. Inner end surfaces 1300, 1302 of the split end 602 extend axially from the inner surface 605 towards an outer surface 1400. The inner end surfaces 1300, 1302 curve radially outward as they approach the outer surface 1400.

The split end 602 is thicker along an axial center line 1402 of the split end 602 and tapers in thickness radially away from the axial center line 1402. This is due to the inner surface 605, which is a planar surface, and the outer surface 1400 that is curved. The split end 602 is thinner near the side members 800, 802 than near the open portion 814. The thick center portion of the split end 602 maintains structural integrity of the split end 602 when pressed onto the strain relief tube 214 of FIG. 2 and during compression of the side members 800, 802.

FIG. 15 shows a compression tool 1500 holding the f-to-f retaining clip 202. The compression tool 1500 is a pair of pliers having handles 1501, 1502, a joint 1504, and compression arms 1506, 1508 and is specialized for compressing the f-to-f retaining clip 202. The handles 1501, 1502 are moved towards each other to compress the side members of the f-to-f retaining clip 202. The compression arms 1506, 1508 have flanges 1510, 1512 configured to hold and compress the side arms of the f-to-f retaining clip 202. The compression tool 1500 or other compression tool may be used to install and/or remove the f-to-f retaining clip 202.

When compression is applied with the compression tool 1500, the jaws of the f-to-f retaining clip 202 rotate to more open positions and the side members extend axially to become less convex and more linearly shaped to ease assembly onto a laser output flange, such as that referred to above. The axial length of the side members thus increases. After assembly and compression force is released, the side members contract to be more convex and less linearly shaped. The length of the side members in the axial direction thus decreases. This captures an optical fiber ferrule to a laser ferrule, such as the above-stated ferrules 700, 212, with an adequate compression force for maintaining proper physical contact of the ferrules.

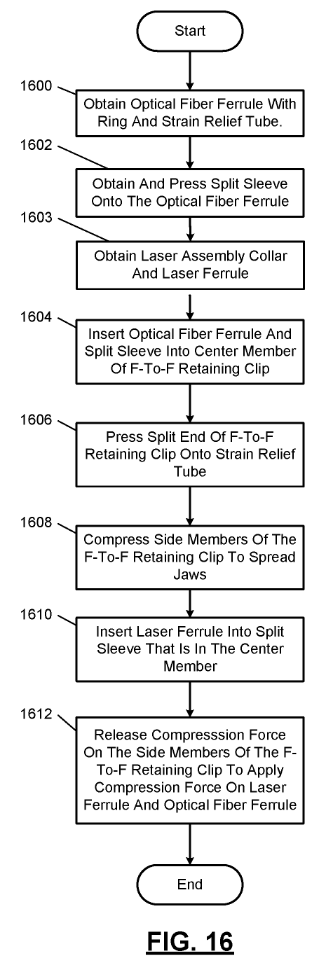

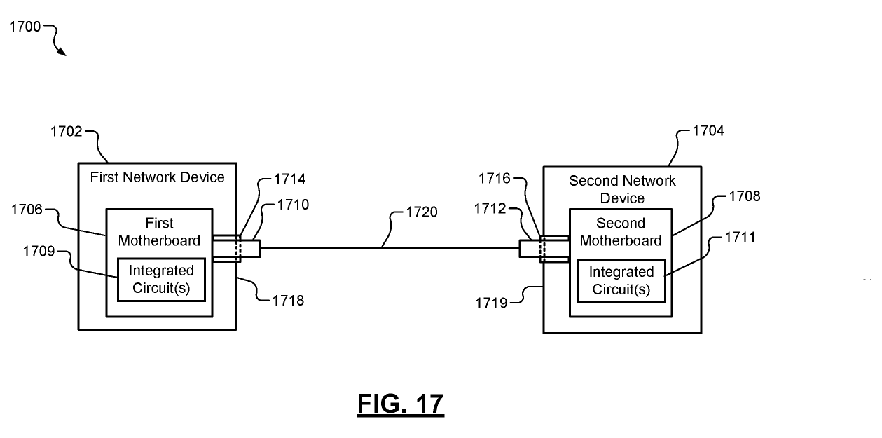

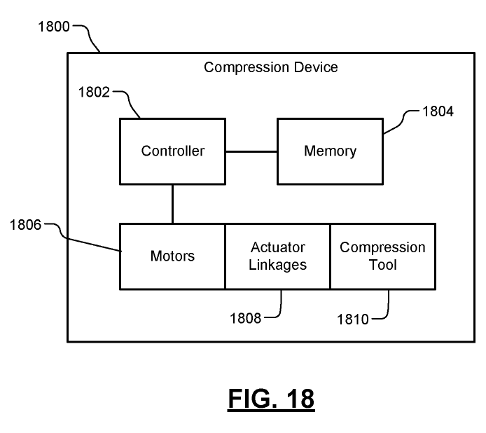

FIG. 16 shows a method for installing the f-to-f retaining clip 202. Referring now to FIGS. 2-3 and 6-16. The following operations may be performed manually via a compression tool (e.g., the compression tool 1500 of FIG. 15) or automatically via a compression device (e.g., a machine, tool, and/or robot) that includes a controller for controlling motors for performing the following operations. An example compression device is shown in FIG. 18. The following operations and the order in which the operations are performed are provided as examples. One or more of the operations may not be performed or performed in a different order than shown.

At 1600, the optical fiber ferrule 212 with the ring 210 and the strain relief tube 214 are obtained. At 1602, the split sleeve 209 is obtained and pressed onto a portion of the optical fiber ferrule 212. At 1603, the laser assembly collar 208 and the laser ferrule 700 are obtained. The laser assembly collar 208 is pressed onto the laser ferrule 700.

At 1604, the optical fiber ferrule 212 and split sleeve 209 are inserted into the center member 808 from an end of the center member 808 closest to the split end 602.

At 1606, the split end 602 of the f-to-f retaining clip 202 is pushed onto the strain relief tube 214 such that the open portion 814 spreads apart until the strain relief tube 214 is inserted into the circular opening 1000 of the split end 602. At this point, the ring 210 contacts the inner surface 605, the split sleeve 209 and the optical fiber ferrule 212 are disposed at least partially in the center member 808.

At 1608, the side members 800, 802 are compressed to open the jaws 810, 812 and axially extend the split end 602 away from the center member 808.

At 1610, the laser ferrule 700 is pressed into a portion of the split sleeve 209 and within the center member 808. The split sleeve 209 is disposed over the portion of the laser ferrule 700. Concurrently, the laser assembly collar 208 is positioned within the jaws 810, 812.

At 1612, the compression force on the side members 800, 802 is released to close the jaws over the laser output flange 600 of the laser assembly collar 208. The side members 800, 802 contract and the split end 602 and jaws 810, 812 compress the ferrules 700, 212 together and hold the ferrules 700, 212 in the compressed state. Once the side members 800, 802 are released, the jaws 810, 812 engage the laser output flange 600 to secure the laser ferrule 700 to the fiber optic ferrule 212.

FIG. 17 shows a communication system 1700 that includes a first network device 1702 and a second network device 1704. The network devices 1702, 1704 are network switches, computers, servers, and/or other network devices. In an embodiment, the network devices 1702, 1704 are network switches that are each connected to multiple other network devices. The network devices 1702, 1704 include respective motherboards 1706, 1708 that each have one or more respective integrated circuits 1709, 1711. The integrated circuits 1709, 1711 include processing circuits, transceivers, etc. for processing and transferring data between the network devices 1702, 1704 and/or other network devices.

Each of the network devices 1702, 1704 further includes one or more pluggable optical transceiver modules. In the example shown, the network devices 1702, 1704 include respective pluggable optical transceiver modules 1710, 1712, which are each configured the same or similarly as the pluggable optical transceiver module 100 of FIG. 1. Although each of the network devices 1702, 1704 is shown having a single port for receiving a single pluggable optical transceiver module, each of the network devices 1702, 1704 can have any number of ports receiving a respective number of pluggable optical transceiver modules. The pluggable optical transceiver modules 1710, 1712 are inserted into cages and/or bezels. Two cages 1714, 1716 are shown. In an embodiment, sides 1718, 1719 of the network devices 1702, 1704 are plates through which the pluggable optical transceiver modules 1710, 1712 and the cages 1714, 1716 extend. In an embodiment, the cages 1714, 1716 are grounded providing electromagnetic interference (EMI) grounding of the pluggable optical transceiver modules 1710, 1712 preventing EMI signals from being transmitted from the pluggable optical transceiver modules 1710, 1712.

The pluggable optical transceiver modules 1710, 1712 are configured for optical communication. In an embodiment, one or more optical cables are connected between the pluggable optical transceiver modules 1710, 1712. Each of the pluggable optical transceiver modules 1710, 1712 is configured similarly or the same as any of the pluggable optical transceiver modules disclosed herein. One cable 1720 is shown connected between the pluggable optical transceiver modules 1710, 1712. The cables connected between the pluggable optical transceiver modules 1710, 1712 of the network devices 1702, 1704 transfer optical data signals between the pluggable optical transceiver modules 1710, 1712.

Each of the disclosed pluggable optical transceiver modules 1710, 1712 is a SFP transceiver module, a QSFP transceiver module, a QSFP-DD transceiver module, an OSFP transceiver module, and/or other pluggable optical transceiver module and includes a f-to-f retaining clip similar to or the same as that shown and described with respect to FIGS. 2-14.

FIG. 18 shows a compression device (e.g., machine, tool, or robot) 1800 that includes a controller 1802, a memory 1804, motors 1806, actuator linkages 1808 and a compression tool 1810. The controller 1802 may control installation and/or removal of f-to-f retaining clips, such as the f-to-f retaining clip 202 of FIGS. 2-14. The controller 1802 may implement the operations of FIG. 16. The compression tool 1810 may be configured the same or differently than the compression tool 1500 of FIG. 15.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

Although the terms first, second, third, etc. may be used herein to describe various elements, components, sides, surfaces, portions, arms, etc. these elements, components, sides, surfaces, portions, arms, etc. should not be limited by these terms, unless otherwise indicated. These terms may be only used to distinguish one element, component, side, surface, portion, arm, etc. from another element, component, side, surface, portion, arm, etc. Terms such as “first,” “second,” and other numerical terms when used herein do not imply a sequence or order unless clearly indicated by the context. Thus, a first element, component, side, surface, portion, arm, etc. could be termed a second element, component, side, surface, portion, arm, etc. without departing from the teachings of the example embodiments.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A ferrule-to-ferrule retaining clip for applying axial compression forces on a laser ferrule and an optical fiber ferrule of a pluggable optical transceiver module, the ferrule-to-ferrule retaining clip comprising:
a bulk end configured to hold a strain relief tube of an optical fiber and abut the optical fiber ferrule;
a plurality of joints;
a center member connected to the plurality of joints and configured to hold the laser ferrule and the optical fiber ferrule;
a plurality of locking members extending from the plurality of joints axially and configured to apply pressure against the laser ferrule; and
a plurality of side members extending axially from the bulk end to the plurality of joints, wherein the plurality of side members are convex shaped and configured to i) spread apart the plurality of locking members when compressed, and ii) cause the bulk end and the plurality of locking members to apply an axial compression force against the laser ferrule and the optical fiber ferrule when not compressed.

2. The ferrule-to-ferrule retaining clip of claim 1, wherein the bulk end is split and configured to be pressed onto the strain relief tube.

3. The ferrule-to-ferrule retaining clip of claim 1, wherein the bulk end is thicker in a center of the bulk end and decreases in thickness in radial directions away from an axial centerline of the bulk end.

4. The ferrule-to-ferrule retaining clip of claim 1, wherein the bulk end comprises i) a planar inner surface and is configured to press against a ring, which is pressed onto the optical fiber ferrule, and ii) a curved outer surface that is on an opposite side of the bulk end than the planar inner surface.

5. The ferrule-to-ferrule retaining clip of claim 1, wherein the center member is cylindrical shaped and configured to hold a split sleeve, which is pressed over respective portions of the laser ferrule and the optical fiber ferrule.

6. The ferrule-to-ferrule retaining clip of claim 1, further comprising a plurality of pivot arms that extend from the plurality of joints and to the center member.

7. The ferrule-to-ferrule retaining clip of claim 1, wherein the center member is suspended between the plurality of joints by a plurality of pivot arms.

8. The ferrule-to-ferrule retaining clip of claim 1, wherein an inner diameter of the center member matches or is greater than an outer diameter of a split sleeve, which is pressed onto respective portions of the laser ferrule and the optical fiber ferrule.

9. The ferrule-to-ferrule retaining clip of claim 1, wherein the plurality of locking members are configured to press on a laser assembly collar, which is on a portion of the laser ferrule.

10. The ferrule-to-ferrule retaining clip of claim 1, wherein the plurality of locking members extend from the plurality of joints axially away from the plurality of side members.

11. The ferrule-to-ferrule retaining clip of claim 1, wherein each locking member of the plurality of locking members is ‘L’-shaped.

12. The ferrule-to-ferrule retaining clip of claim 1, wherein each locking member of the plurality of locking members comprises an axially extending inner surface and an angled inner surface, which is at an acute angle relative to the axially extending inner surface.

13. The ferrule-to-ferrule retaining clip of claim 1, wherein the plurality of locking members comprises chamfered end surfaces aiding in spreading and bringing together the plurality of locking members.

14. The ferrule-to-ferrule retaining clip of claim 1, wherein each of the plurality of locking members comprises a curved radially inner surface configured to abut a laser assembly collar, which is pressed on the laser ferrule.

15. The ferrule-to-ferrule retaining clip of claim 1, wherein the ferrule-to-ferrule retaining clip is formed of injection molded plastic resin.

16. An optical transceiver module comprising:
an upper housing;
a lower housing coupled to the upper housing;
a laser package disposed in the lower housing;
a laser assembly collar connected to the laser package;
a split sleeve;
a laser ferrule extending into the laser assembly collar and into a split sleeve;
an optical fiber ferrule extending into the split sleeve; and
a ferrule-to-ferrule retaining clip configured to apply axial compression forces on the laser ferrule and the optical fiber ferrule, the ferrule-to-ferrule retaining clip comprising
a bulk end configured to abut the optical fiber ferrule,
a center member configured to hold the laser ferrule and the optical fiber ferrule,
a plurality of locking members configured to apply pressure against the laser ferrule, and
a plurality of side members extending axially from the bulk end, wherein the plurality of side members are convex shaped and configured to spread apart the plurality of locking members when compressed.

17. The optical transceiver module of claim 16, wherein:
the ferrule-to-ferrule retaining clip comprises a plurality of joints;
the center member is connected to the plurality of joints;
the plurality of locking members extend axially from the plurality of joints; and
the plurality of side members extend axially from the bulk end to the plurality of joints.

18. A method of installing a ferrule-to-ferrule retaining clip, wherein the ferrule-to-ferrule retaining clip comprises a bulk end, side members, a center member and a plurality of locking members, the method comprising:
obtaining an optical fiber ferrule with a strain relief tube;
obtaining and pressing a split sleeve onto the optical fiber ferrule;
obtaining a laser assembly collar and laser ferrule;
inserting the optical fiber ferrule and split sleeve into the center member;
pressing the bulk end onto the strain relief tube;
controlling a motor via a controller to compress the side members to spread the plurality of locking members;
inserting the laser ferrule into split sleeve, which is in the center member; and
controlling the motor via the controller to release the plurality of locking members over the laser assembly collar and to axially compress the laser ferrule against the optical fiber ferrule.

19. The method of claim 18, wherein compressing the side members comprises moving the bulk end axially outward.

20. The method of claim 18, wherein releasing the plurality of locking members comprises pressing the plurality of locking members over a laser output flange of the laser assembly collar.
